(19) United States
(12) Patent Application Publication
(10) Pub. No.: US 2024/0087232 A1
(43) Pub. Date: Mar. 14, 2024

(54) SYSTEMS AND METHODS OF THREE-DIMENSIONAL MODELING BASED ON OBJECT TRACKING

(71) Applicant: QUALCOMM Incorporated, San Diego, CA (US)

(72) Inventors: Laurent Ghislain GAIDON, Peujard (FR); Eduardo ESTEVES, San Diego, CA (US); Philipp Franz NAGELE, Salzburg (AT)

(21) Appl. No.: 17/932,246

(22) Filed: Sep. 14, 2022

(51) Int. Cl. G06T 17/20; G02B 27/01; G06F 3/01; G06T 7/20; G06T 7/543; G06T 7/70; G06T 15/04; G06T 19/20; G06V 40/20

(52) U.S. Cl. CPC G06T 17/205; G02B 27/017; G06F 3/017; G06T 7/20; G06T 7/543; G06T 7/70; G06T 15/04; G06T 19/20; G06V 40/28; G06T 2207/30244; G06T 2219/2021

(57) ABSTRACT

Imaging systems and techniques are described. An imaging system determines, based on image data of a scene received from an image sensor, a movement path of an indicator object relative to a target object. The target object is represented in the image data from a first perspective. The imaging system identifies, based on the movement path of the indicator object and the first perspective, an outline of at least a portion of the target object. The imaging system generates a three-dimensional mesh based on the outline of at least the portion of the target object. The imaging system can generate the mesh additively or subtractively, by adding a volume based on the outline to a previous mesh or by subtracting the volume from a previous mesh, respectively. The imaging system can generate a texture for the mesh that is based on the target object in the image data.

### FIELD

This application is related to image capture and processing. More specifically, this application relates to systems and methods of using image data from an image sensor to track movement of an indicator object, such as a user's hand, relative to a detected outline of a target object, and to generate a three-dimensional mesh based on the movement and/or the detected outline.

### BACKGROUND

Many devices include one or more cameras. For example, a smartphone or tablet includes a front facing camera to capture selfie images and a rear facing camera to capture an image of a scene (such as a landscape or other scenes of interest to a device user). A camera can capture images using an image sensor of the camera, which can include an array of photodetectors. Some devices can analyze image data captured by an image sensor to detect an object within the image data.

### BRIEF SUMMARY

In some examples, systems and techniques are described for image processing. An imaging system determines, based on image data of a scene received from an image sensor, a movement path of an indicator object (e.g., a hand, a finger, a pointer, etc.) relative to a target object. The target object is represented in the image data from a first perspective. The imaging system identifies, based on the movement path of the indicator object and the first perspective, an outline of at least a portion of the target object. The imaging system generates a three-dimensional mesh based on the outline of at least the portion of the target object. The imaging system can generate the mesh additively by adding a volume that is based on the outline to a previous mesh. The imaging system can generate the mesh subtractively by removing a volume that is based on the outline from previous instance mesh. The imaging system can generate a texture for the mesh that is based on the target object as represented in the image data.

According to at least one example, a method is provided for image-based modeling. The method includes: determining, based on image data of a scene received from an image sensor, a movement path of an indicator object relative to a target object, wherein the target object is represented in the image data from a first perspective; identifying, based on the movement path of the indicator object and the first perspective, an outline of at least a portion of the target object; and generating a three-dimensional mesh based on the outline of at least the portion of the target object.

In another example, an apparatus for image-based modeling is provided that includes at least one memory and at least one processor coupled to the at least one memory. The at least one processor is configured to: determine, based on image data of a scene received from an image sensor, a movement path of an indicator object relative to a target object, wherein the target object is represented in the image data from a first perspective; identify, based on the movement path of the indicator object and the first perspective, an outline of at least a portion of the target object; and generate a three-dimensional mesh based on the outline of at least the portion of the target object.

In another example, a non-transitory computer-readable medium is provided that has stored thereon instructions that, when executed by one or more processors, cause the one or more processors to: determine, based on image data of a scene received from an image sensor, a movement path of an indicator object relative to a target object, wherein the target object is represented in the image data from a first perspective; identify, based on the movement path of the indicator object and the first perspective, an outline of at least a portion of the target object; and generate a three-dimensional mesh based on the outline of at least the portion of the target object.

In another example, an apparatus for image-based modeling is provided. The apparatus includes: means for determining, based on image data of a scene received from an image sensor, a movement path of an indicator object relative to a target object, wherein the target object is represented in the image data from a first perspective; means for identifying, based on the movement path of the indicator object and the first perspective, an outline of at least a portion of the target object; and means for generating a three-dimensional mesh based on the outline of at least the portion of the target object.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a block diagram illustrating an example architecture of a sensor data processing system that performs a process for object tracking and three-dimensional modeling, in accordance with some examples;

FIG. 3A is a perspective diagram illustrating a head-mounted display (HMD) that is used as part of an imaging system, in accordance with some examples;

FIG. 3B is a perspective diagram illustrating the head-mounted display (HMD) of FIG. 3A being worn by a user, in accordance with some examples;

FIG. 4A is a perspective diagram illustrating a front surface of a mobile handset that includes front-facing cameras and that can be used as part of an imaging system, in accordance with some examples;

FIG. 4B is a perspective diagram illustrating a rear surface of a mobile handset that includes rear-facing cameras and that can be used as part of an imaging system, in accordance with some examples;

FIG. 5 is a conceptual diagram illustrating a modeling process for generation of a three-dimensional model of a target object (a can) based on tracking of a movement path of an indicator object (a user's finger) relative to the target object, in accordance with some examples;

FIG. 6 is a conceptual diagram illustrating a first modeling process for subtractive generation of a three-dimensional model of a target object (a person) based on tracking of a movement path of an indicator object (a user's finger) relative to the target object, in accordance with some examples;

FIG. 7 is a conceptual diagram illustrating a second modeling process for subtractive generation of a three-dimensional model of a target object (a person) based on tracking of a movement path of an indicator object (a user's finger) relative to the target object, in accordance with some examples;

FIG. 8 is a conceptual diagram illustrating a modeling process for generation of a three-dimensional model of a target object (a ball) based on tracking of movement(s) of the target object and/or an indicator object (a user's hand) relative to the target object, in accordance with some examples;

FIG. 9 is a block diagram illustrating an example of a neural network that can be used for object tracking and three-dimensional modeling operations, in accordance with some examples;

FIG. 10 is a flow diagram illustrating a process for three-dimensional modeling based on object tracking, in accordance with some examples; and

FIG. 11 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

A device that includes a camera can analyze image data captured by an image sensor to detect, recognize, classify, and/or track an object within the image data. For instance, by detecting and/or recognizing an object in multiple video frames of a video, the device can track movement of the object over time.

In some examples, systems and techniques are described for image processing. An imaging system determines, based on image data of a scene received from an image sensor, a movement path of an indicator object (e.g., a hand, a finger, a pointer, etc.) relative to a target object. The target object is represented in the image data from a first perspective. The imaging system identifies, based on the movement path of the indicator object and the first perspective, an outline of at least a portion of the target object. The imaging system generates a three-dimensional mesh based on the outline of at least the portion of the target object. The imaging system can generate the mesh additively by adding a volume that is based on the outline to a previous mesh. The imaging system can generate the mesh subtractively by removing a volume that is based on the outline from previous instance mesh. The imaging system can generate a texture for the mesh that is based on the target object as represented in the image data.

The sensor processing and 3D modeling systems and techniques described herein provide a number of technical improvements over prior sensor processing and 3D modeling systems. For instance, the sensor processing and 3D modeling systems and techniques described herein provide a quick and efficient process though which a 3D mesh and/or 3D model can be generated based on at least a portion (e.g., at least one edge, curvature, or contour) of a real-world object, that does not require a specialized multi-camera 3D scanning rig system. The sensor processing and 3D modeling systems and techniques described herein are flexible, allowing for 3D modeling based, for example, on a combination of a first part of one real-world object, a second part of a second real-world object, and so on. The sensor processing and 3D modeling systems and techniques described herein improve accuracy of 3D modeling, since the edges (e.g., curvatures and/or contours) of the target object is used as a template to simplify and guide scanning and modeling.

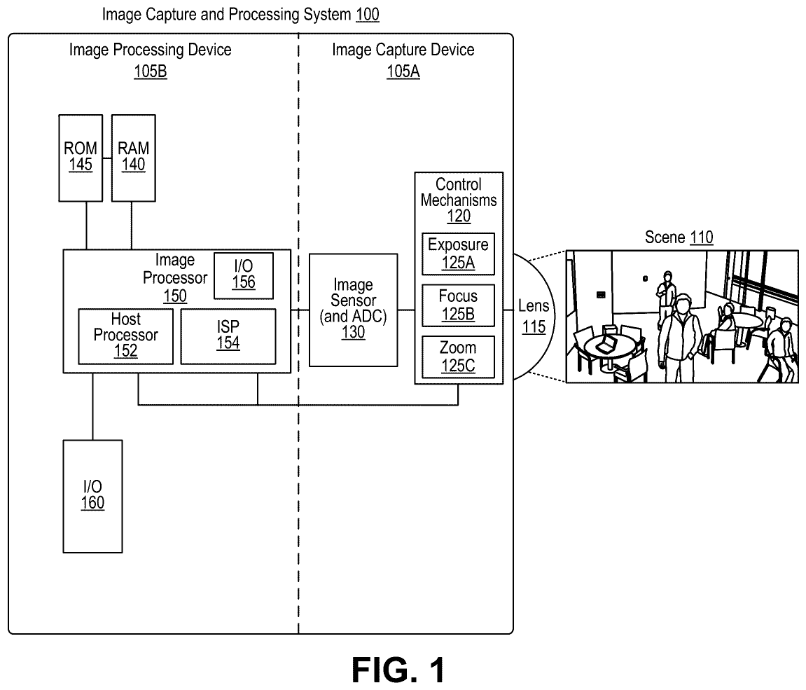

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1110 discussed with respect to the computing system 1100. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 1120, read-only memory (ROM) 145 and/or 1125, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1102.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

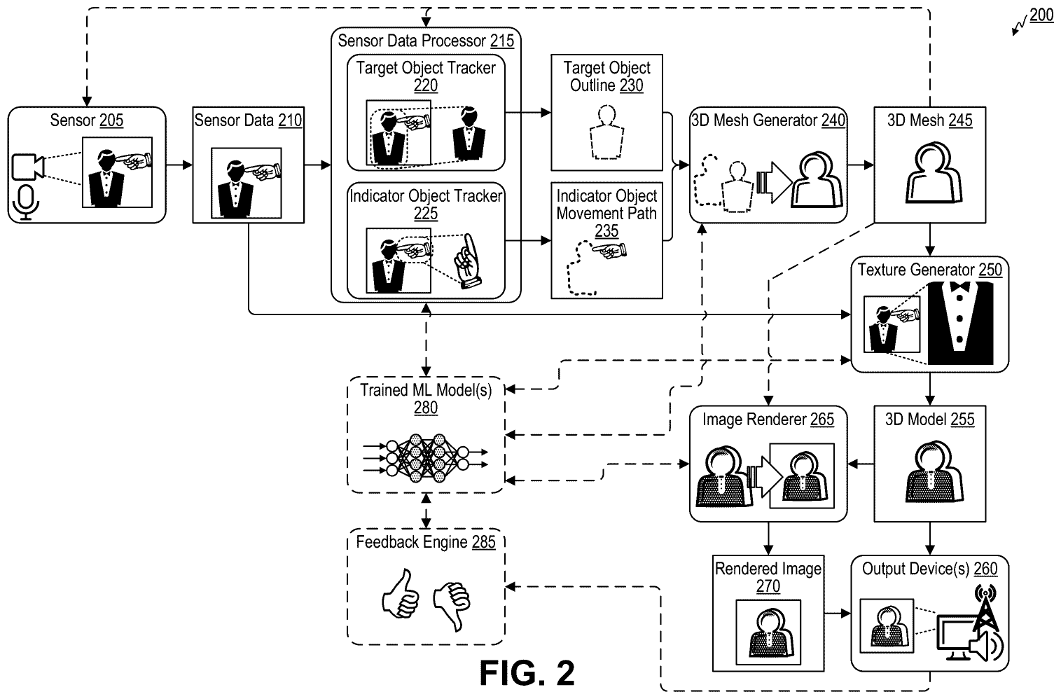

FIG. 2 is a block diagram illustrating an example architecture of a sensor data processing system 200 that performs a process for object tracking and three-dimensional modeling. The sensor data processing system 200 can include at least one of the image capture and processing system 100, the image capture device 105A, the image processing device 105B, the HMD 310, the mobile handset 410, the neural network 900, the sensor data processing system that performs the process 1000, the computing system 1100, the processor 1110, or a combination thereof. In some examples, the sensor data processing system 200 can include, for instance, one or more laptops, phones, tablet computers, mobile handsets, video game consoles, vehicle computers, desktop computers, wearable devices, televisions, media centers, extended reality (XR) systems, virtual reality (VR) systems, augmented reality (AR) systems, mixed reality (MR) systems, head-mounted display (HMD) devices, other types of computing devices discussed herein, or combinations thereof.

The sensor data processing system 200 includes at least one sensor 205 that captures sensor data 210. Examples of the sensor 205 include the image capture and processing system 100, the image capture device 105A, the image processing device 105B, the image sensor 130, image sensor(s) of any of cameras 330A-330D, image sensor(s) of any of cameras 430A-430D, an image sensor that captures an image that is used in the input layer 910 of the NN 900, the image sensor of the imaging process 1000, an image sensor of an input device 1145, or a combination thereof. In some examples, the sensor data 210 includes raw image data, image data, pixel data, image frame(s), raw video data, video data, video frame(s), or a combination thereof.

In some examples, the at least one sensor 205 can be, or can include, an image sensor with an array of photodetectors. The photodetectors of the image sensor can be sensitive to one or more subsets of the electromagnetic (EM) frequency domain, such as the radio EM frequency domain, the microwave EM frequency domain, the infrared (IR) EM frequency domain, the visible light (VL) EM frequency domain, the ultraviolet (UV) EM frequency domain, the X-Ray EM frequency domain, the gamma ray EM frequency domain, a subset of any of these, or a combination thereof. In some examples, different photodetectors of the image sensor can be configured to be sensitive to different EM frequency domains and/or different color channels. In some examples, the sensor 205 captures multiple image frames configured to be arranged in a sequence to form a video, and the sensor data 210 includes at least a subset of the video (e.g., at least one video frame of the video).

In some examples, the sensor 205 can be directed toward a user (e.g., can face toward the user), and can thus capture sensor data (e.g., image data) of (e.g., depicting or otherwise representing) at least portion(s) of the user. In some examples, the sensor 205 can be directed away from the user (e.g., can face away from the user) and/or toward an environment that the user is in, and can thus capture sensor data (e.g., image data) of (e.g., depicting or otherwise representing) at least portion(s) of the environment. In some examples, sensor data 210 captured by the sensor 205 is directed away from the user and/or toward the user. In some examples, sensor data 210 captured by the sensor 205 is can have a field of view (FoV) that includes, is included by, overlaps with, and/or otherwise corresponds to, a FoV of the eyes of the user.

In some examples, sensor 205 can be, or can include, other types of sensors other than image sensors. In some examples, the sensor data processing system 200 can also include one or more other sensors in addition to the sensor 205, such as one or more other image sensors and/or one or more other types of sensors. Sensor types can include, for instance, image sensors, cameras, microphones, heart rate monitors, oximeters, biometric sensors, positioning receivers, Global Navigation Satellite System (GNSS) receivers, Inertial Measurement Units (IMUs), accelerometers, gyroscopes, gyrometers, barometers, thermometers, altimeters, depth sensors, light detection and ranging (LIDAR) sensors, radio detection and ranging (RADAR) sensors, sound detection and ranging (SODAR) sensors, sound navigation and ranging (SONAR) sensors, time of flight (ToF) sensors, structured light sensors, other sensors discussed herein, or combinations thereof. In some examples, the one or more sensors 205 include at least one input device 1145 of the computing system 1100. In some implementations, one or more of these additional sensor(s) may complement or refine sensor readings from the sensor 205. For example, Inertial Measurement Units (IMUs), accelerometers, gyroscopes, or other sensors may be used to identify a pose (e.g., position and/or orientation) and/or motion(s) and/or acceleration(s) of the sensor data processing system 200 and/or of the user in the environment, which can be used by the sensor data processing system 200 to reduce motion blur, rotation blur, or combinations thereof.

A graphic representing the sensor 205 is illustrated in FIG. 2, and illustrates a sensor (e.g., an image sensor) capturing a representation (e.g., an image) of a scene with a target object and an indicator object. In particular, the target object is a person wearing a tuxedo, and the indicator object is a hand (e.g., of a user using the sensor data processing system 200 or of another user). A graphic representing the sensor data 210 is illustrated in FIG. 2, and illustrates the representation (e.g., image) of the scene with the target object and the indicator object that is captured by the sensor 205.

The sensor data processing system 200 includes a sensor data processor 215. The sensor data processor 215 can include the image processing device 105B, the image processor 150, the host processor 152, the ISP 154, a target object tracker 220, an indicator object tracker 225, a three-dimensional (3D) mesh generator 240, a texture generator 250, one or more output devices 260, one or more trained machine learning (ML) models 280, a feedback engine 285, the HMD 310, the mobile handset 410, the neural network 900, the sensor data processing system that performs the process 1000, the computing system 1100, the processor 1110, or a combination thereof. The target object tracker 220 and the indicator object tracker 225 of the sensor data processor 215 both analyze the sensor data 210 to detect, recognize, classify, and/or track one or more features, objects, and/or environments. Tracking, as used herein, can refer to tracking an observed path of an element (e.g., a feature, an object, and/or an aspect of the environment), predicting a path of the element (e.g., based on the path that is observed and/or tracked), or a combination thereof. Features can include, for instance, edges, corners, blobs, other points of interest, descriptors, or a combination thereof. Objects can include, for instance, faces, persons, hands, fingers, pointers, vehicles, animals, plants, structures, any target objects discussed herein, any indicator objects discussed herein, any object pointed at by an indicator object as discussed herein, or a combination thereof.

In some examples, to detect, recognize, classify, and/or track an element (e.g., a feature, an object, and/or an aspect of the environment), the target object tracker 220 and the indicator object tracker 225 of the sensor data processor 215 can input the sensor data 210 into the trained ML model(s) 280. The sensor data processing system 200 can use training data to pre-train the trained ML model(s) 280 to detect, recognize, classify, and/or track one or more features, objects, and/or environments. The training data can include sensor data (e.g., of the same type or a similar type as the sensor data 210) as well as pre-determined indications of areas in the sensor data that include certain features, objects, and/or aspects of an environment. In some examples, the sensor data in the training data can include video data, and the training data can include tracked paths of elements (e.g., certain features, objects, and/or aspects of the environment) and/or predicted paths of elements (e.g., certain features, objects, and/or aspects of the environment). In some examples, the sensor data processing system 200 can iteratively train the trained ML model(s) 280 further based on a degree of success in detecting, recognizing, classifying, and/or tracking the element based on the sensor data 210.

In particular, the target object tracker 220 is configured to detect, recognize, classify, and/or track a target object in the sensor data 210. The indicator object tracker 225 is configured to detect, recognize, classify, and/or track an indicator object in the sensor data 210. The indicator object is an object in the environment that is used to indicate a position, area, volume, and/or path (e.g., if the indicator object moves along the path) within the environment, for instance by pointing at, touching, and/or grasping (e.g., holding onto) the position, area, volume, and/or path. For instance, the indicator object can be a hand, a finger, a fingertip, a pointer, a rod, a light point of a laser pointer, a leg, a foot, a toe, an appendage, another type of indicator object described herein, portion(s) thereof, or combination(s) thereof. The target object can be any type of object, such as a face, a person, a vehicle, an animal, a plant, a statue, a toy, a structure, any of the object types discussed above with respect to the indicator object, any other object types described herein, portion(s) thereof, or combination(s) thereof.

By detecting, recognizing, classifying, and/or tracking the target object within the sensor data 210, the target object tracker 220 generates a target object outline 230. The target object outline 230 can identify an outline of at least a portion of one or more edges, sides, corners, and/or surface(s) of the target object. The outline(s) in the target object outline 230 can depend on the perspective of the sensor data 210 relative to the target object. For instance, if the target object is a person's head, and the perspective is a side profile, then the outline(s) in the target object outline 230 can include the curvature and/or contours of the person's nose, lips, and/or eyes. On the other hand, if the perspective is facing the front of the person's head, then the resulting outline(s) in the target object outline 230 could instead include curvature and/or contours of the person's ears.

A graphic representing the target object tracker 220 is illustrated in FIG. 2, and illustrates a bounding box (with dashed lines) around the representation of the target object (the person wearing the tuxedo) in the exemplary sensor data in the graphic representing the sensor data 210. A graphic representing the target object outline is illustrated in FIG. 2, and illustrates an exterior edge of the representation of the target object (the person wearing the tuxedo) in the sensor data 210, as represented from the perspective on the target object in the exemplary sensor data in the graphic representing the sensor data 210.

By detecting, recognizing, classifying, and/or tracking the indicator object within the sensor data 210, the indicator object tracker 225 generates an indicator object movement path 235. The indicator object movement path 235 can identify path (e.g., observed and/or predicted) of the indicator object as tracked by the indicator object tracker 225. In particular, the indicator object tracker 225 can generate the indicator object movement path 235 to identify a path of the indicator object as the indicator object moves within, and/or stays within, a threshold distance of at least a portion of one or more edges, sides, corners, and/or surface(s) of the target object. In some examples, the indicator object can trace an outline of a portion of the one or more edges, sides, corners, and/or surface(s) of the target object. As discussed above, the edges, sides, corners, and/or surface(s) of the target object that the indicator object can trace an outline of can depend on the perspective of the sensor data 210 relative to the target object.

A graphic representing the indicator object tracker 225 is illustrated in FIG. 2, and illustrates a bounding box (with dashed lines) around the representation of the indicator object (the hand) in the exemplary sensor data in the graphic representing the sensor data 210. A graphic representing the indicator object movement path 235 is illustrated in FIG. 2, and illustrates an indicator object movement path 235 (using a dashed line) of the indicator object (the hand) tracing around a portion of an exterior of the target object (the person wearing the tuxedo) in the graphic representing the sensor data 210.

In some examples, to generate the target object outline 230, the sensor data processor 215 (e.g., the target object tracker 220) can input the sensor data 210 into the trained ML model(s) 280. In some examples, the sensor data processor 215 (e.g., the target object tracker 220) can also input an indication of what object is the target object into the trained ML model(s) 280. The indication can be based on the indicator object tracking by the indicator object tracker 225, since the indicator object points to and/or traces an edge of the target object, thereby identifying which object in the environment is the target object. In some examples, the trained ML model(s) 280 can determine the identity of the target object based on the sensor data 210. The sensor data processing system 200 can use training data to pre-train the trained ML model(s) 280 to generate the target object outline 230 based on the sensor data 210 and/or the indication of the identity of the target object. The training data can include sensor data (e.g., of the same type or a similar type as the sensor data 210), an identity of a target object in the sensor data, and a pre-determined outline of the target object. In some examples, the sensor data processing system 200 can iteratively train the trained ML model(s) 280 further based on a degree of success in generation of the target object outline 230 based on the sensor data 210.

In some examples, to generate the indicator object movement path 235, the sensor data processor 215 (e.g., the indicator object tracker 225) can input the sensor data 210 into the trained ML model(s) 280. In some examples, the sensor data processor 215 (e.g., the indicator object tracker 225) can also input an indication of what object is the indicator object into the trained ML model(s) 280. The indication can be based on classification of object types in the sensor data 210 to identify a hand, a finger, fingertip, a pointer, an appendage, or any of the other types of indicator object discussed above. The indication can also be on identifying an object that is moving more than a threshold amount (e.g., threshold distance) in the scene to be the indicator object. In some examples, the trained ML model(s) 280 can determine the identity of the indicator object based on the sensor data 210. The sensor data processing system 200 can use training data to pre-train the trained ML model(s) 280 to generate the indicator object movement path 235 based on the sensor data 210 and/or the indication of the identity of the indicator object. The training data can include sensor data (e.g., of the same type or a similar type as the sensor data 210), an identity of a indicator object in the sensor data, and a pre-determined movement path of the indicator object. In some examples, the sensor data processing system 200 can iteratively train the trained ML model(s) 280 further based on a degree of success in generation of the indicator object movement path 235 based on the sensor data 210.

The sensor data processing system 200 includes a three-dimensional (3D) mesh generator 240. The 3D mesh generator 240 can include the image processing device 105B, the image processor 150, the host processor 152, the ISP 154, the sensor data processor 215, a target object tracker 220, an indicator object tracker 225, a texture generator 250, one or more output devices 260, one or more trained machine learning (ML) models 280, a feedback engine 285, the AMD 310, the mobile handset 410, the neural network 900, the sensor data processing system that performs the process 1000, the computing system 1100, the processor 1110, or a combination thereof. The 3D mesh generator 240 receives the target object outline 230 and the indicator object movement path 235 from the sensor data processor 215. The 3D mesh generator 240 generates a three-dimensional (3D) mesh 245 based on the target object outline 230 and/or the indicator object movement path 235. The 3D mesh generator 240 can generate the 3D mesh 245 by projecting a 3D volume based on the target object outline 230 and/or the indicator object movement path 235. For instance, an outline of an edge (e.g., a curvature and/or contours of the edge) of the 3D mesh 245 (and/or the 3D volume) can match an outline of at least a portion of an edge of the target object outline 230 and/or the indicator object movement path 235. For instance, the 3D mesh generator 240 can generate the 3D mesh 245 based on a specified portion of the target object outline 230 that is traced in the indicator object movement path 235. In some examples, the 3D mesh generator 240 can generate portion(s) of the 3D mesh 245 based only on the target object outline 230, and not on the indicator object movement path 235 (e.g., where there is an error or discontinuity in the indicator object movement path 235). In some examples, the 3D mesh generator 240 can generate portion(s) of the 3D mesh 245 based only on the indicator object movement path 235, and not on the target object outline 230 (e.g., where there is an error or discontinuity in the target object outline 230).

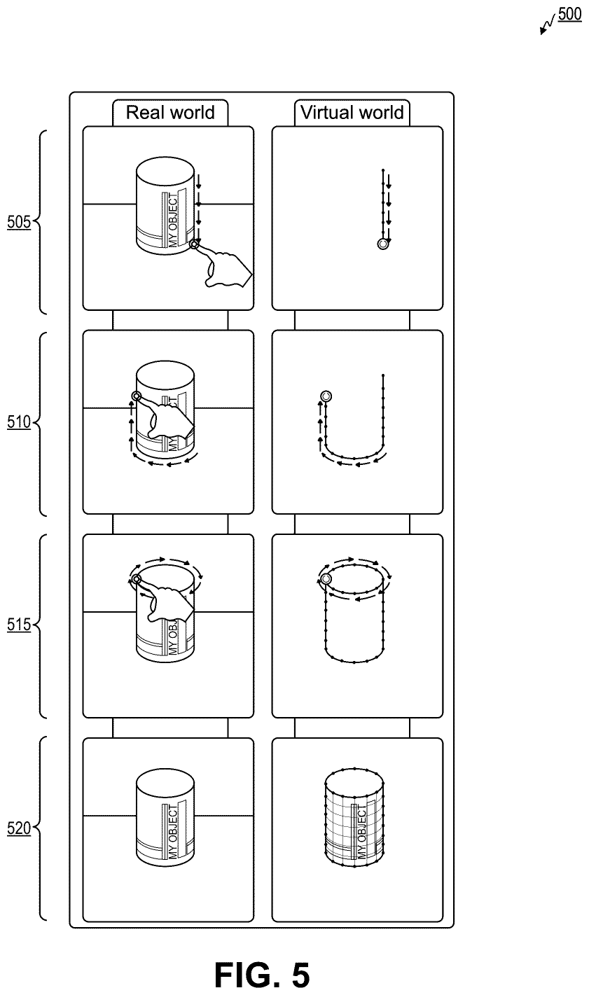

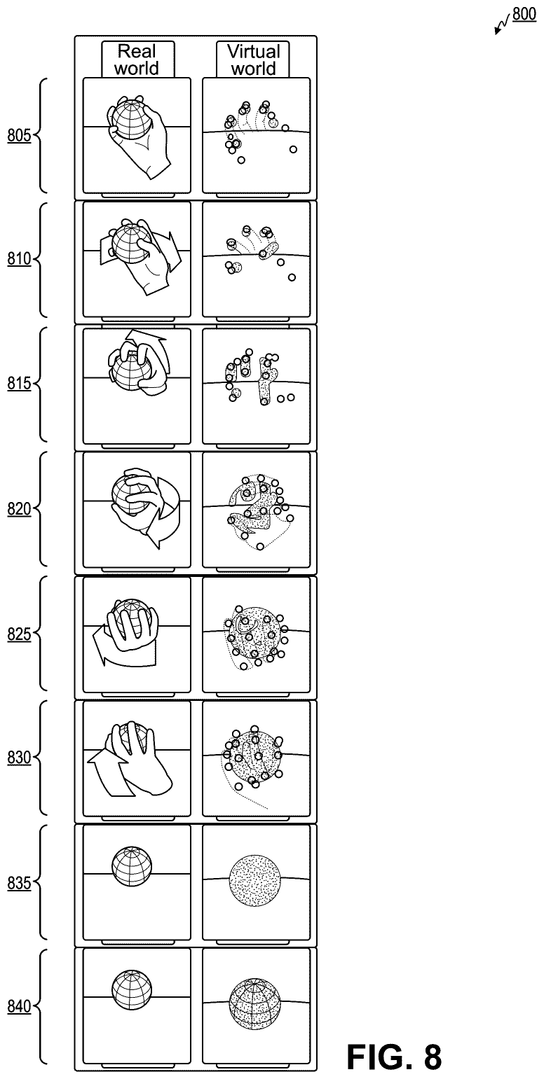

In some examples, the 3D mesh generator 240 can generate the 3D mesh 245 additively. For instance, the 3D mesh generator 240 can generate a 3D volume by projecting the 3D volume based on the target object outline 230 and/or the indicator object movement path 235. The 3D mesh generator 240 can generate the 3D mesh 245 by including the 3D volume to be in the 3D mesh 245. For instance, if the 3D mesh generator 240 has not yet generated any 3D mesh 245, the 3D volume can be the 3D mesh 245. If the 3D mesh generator 240 already has a pre-determined 3D mesh, the 3D mesh generator 240 can add the 3D volume to the pre-determined 3D mesh to generate the 3D mesh 245, so that the 3D volume becomes part of the 3D mesh 245. Examples of additive generation of the 3D mesh 245 by the 3D mesh generator 240 are illustrated in FIG. 5 and FIG. 8.

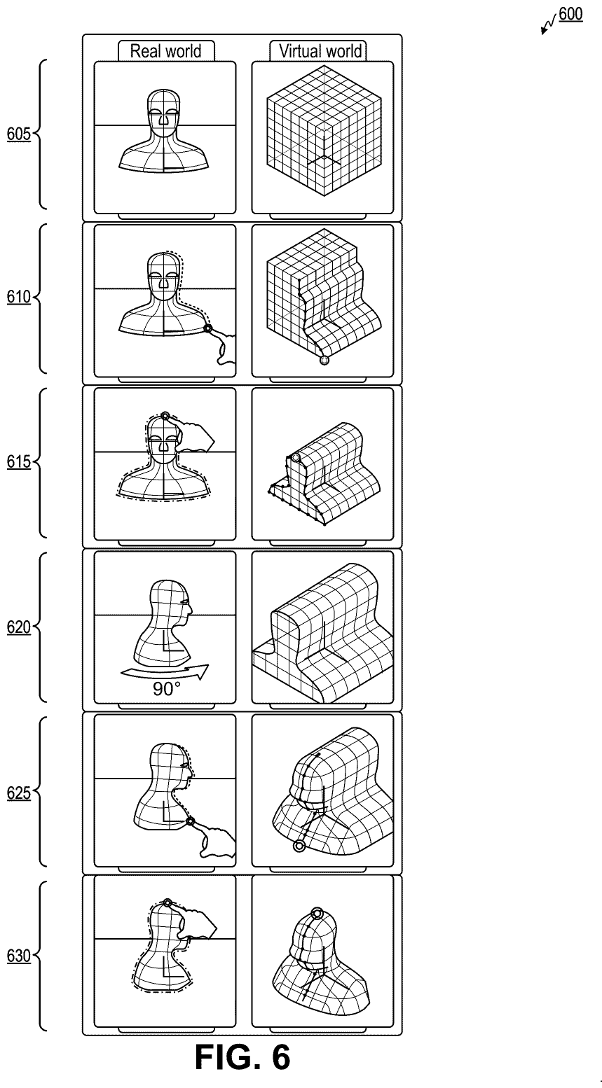

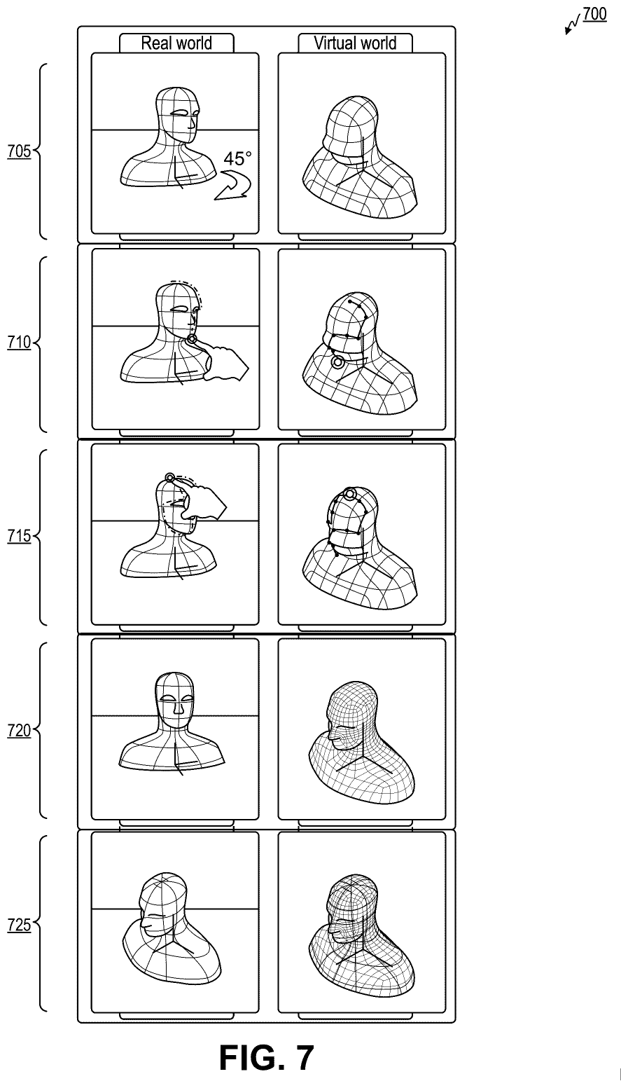

In some examples, the 3D mesh generator 240 can generate the 3D mesh 245 subtractively. For instance, the 3D mesh generator 240 can generate a 3D volume by projecting the 3D volume based on the target object outline 230 and/or the indicator object movement path 235. The 3D mesh generator 240 can generate the 3D mesh 245 by removing the 3D volume from a pre-determined 3D mesh. After the 3D mesh generator 240 removes the 3D volume from the pre-determined 3D mesh, the result can be the 3D mesh 245. For instance, in an illustrative example, the pre-determined 3D mesh can be a 3D block. The 3D mesh generator 240 can generate the 3D mesh 245 subtractively by removing portions of the 3D block to generate the 3D mesh 245. Examples of subtractive generation of the 3D mesh 245 by the 3D mesh generator 240 are illustrated in FIGS. 6-7.

In some examples, to generate the 3D mesh 245 (and/or the 3D volume discussed above) based on the target object outline 230 and/or the indicator object movement path 235, the 3D mesh generator 240 can input the target object outline 230 and/or the indicator object movement path 235 into the trained ML model(s) 280. The sensor data processing system 200 can use training data to pre-train the trained ML model(s) 280 to generate the 3D mesh 245 (and/or the 3D volume discussed above) based on the target object outline 230 and/or the indicator object movement path 235. The training data can include sensor data (e.g., of the same type or a similar type as the sensor data 210), a target object outline (e.g., as in the target object outline 230) of a target object represented in the sensor data, an indicator object movement path (e.g., as in the indicator object movement path 235) of an indicator object represented in the sensor data, and/or a pre-generated 3D mesh that is based on the sensor data and/or the target outline and/or the indicator object movement path (e.g., as in the 3D mesh 245 and/or 3D the volume discussed above). In some examples, the sensor data processing system 200 can iteratively train the trained ML model(s) 280 further based on a degree of success in generation of the 3D mesh 245 (and/or the 3D volume discussed above) based on the target object outline 230 and/or the indicator object movement path 235.

A graphic representing the 3D mesh generator 240 is illustrated in FIG. 2, and illustrates an arrow from the graphics representing the target object outline 230 and the indicator object movement path 235 to a graphic representing the 3D mesh 245. The graphic representing the 3D mesh 245 is a 3D shape whose outline is based on the target object outline 230 of the target object (e.g., the person wearing the tuxedo). The graphic representing the 3D mesh 245 is illustrated to resemble the 3D mesh at stage 615 and stage 620 of the modeling process 600.

The sensor data processing system 200 includes a texture generator 250. The texture generator 250 can include the image processing device 105B, the image processor 150, the host processor 152, the ISP 154, the sensor data processor 215, a target object tracker 220, an indicator object tracker 225, the 3D mesh generator 240, one or more output devices 260, one or more trained machine learning (ML) models 280, a feedback engine 285, the HMD 310, the mobile handset 410, the neural network 900, the sensor data processing system that performs the process 1000, the computing system 1100, the processor 1110, or a combination thereof. The texture generator 250 generates a texture for the 3D mesh 245 based on the shape of the 3D mesh 245 and based on an appearance of the target object in the sensor data 210 (e.g., as tracked using the target object tracker 220). For instance, if the target object is a person, the 3D mesh 245 may have a shape that is based on the edge(s) of the person as represented in the sensor data 210, and the texture may apply colors (e.g., skin tone, eye color, lip color, clothing colors, accessory colors, and/or colors of other portions of the target object) and/or patterns (e.g., skin texture, clothing texture, clothing patterns, hair texture) from the representation of the person to the 3D mesh 245. Once the texture generator 250 generates the texture for the 3D mesh 245, the texture generator 250 can also apply the texture to the 3D mesh 245 to generate a 3D model 255 with the texture applied to the 3D mesh 245.

In some examples, to generate the texture based on the 3D mesh 245 and the sensor data 210, the texture generator 250 can input the 3D mesh 245 and the sensor data 210 into the trained ML model(s) 280. In some examples, the texture generator 250 can also input an indication of the position(s) and/or area(s) of the representation of the target object in the sensor data 210 (e.g., as determined and/or tracked by the target object tracker 220) and/or an indication of the identity of the target object. The sensor data processing system 200 can use training data to pre-train the trained ML model(s) 280 to generate the texture based on the 3D mesh 245 and the sensor data 210. The training data can include a 3D mesh (e.g., as in the 3D mesh 245), sensor data (e.g., of the same type or a similar type as the sensor data 210), and a pre-generated texture for the 3D mesh based on the sensor data. In some examples, the sensor data processing system 200 can iteratively train the trained ML model(s) 280 further based on a degree of success in generation of the texture based on the 3D mesh 245 and the sensor data 210.

A graphic representing the texture generator 250 is illustrated in FIG. 2, and illustrates a texture of a tuxedo being extracted from the graphic representing the sensor data 210. A graphic representing the 3D model 255 is illustrated in FIG. 2, and illustrates a texture of a tuxedo applied to the graphic representing the 3D mesh 245.

The sensor data processing system 200 includes one or more output device(s) 260. In some examples, the sensor data processing system 200 sends the 3D mesh 245 and/or 3D model 255 to the output device(s) 260 directly. In some examples, the sensor data processing system 200 sends a rendered image 270 of the 3D model 255 to the one or more output device(s) 260 instead of, or in addition to, the 3D mesh 245 and/or the 3D model 255. In some examples, the sensor data processing system 200 includes an image renderer 265. The image renderer 265 can include the image processing device 105B, the image processor 150, the host processor 152, the ISP 154, the sensor data processor 215, a target object tracker 220, an indicator object tracker 225, the 3D mesh generator 240, one or more output devices 260, one or more trained machine learning (ML) models 280, a feedback engine 285, the MD 310, the mobile handset 410, the neural network 900, the sensor data processing system that performs the process 1000, the computing system 1100, the processor 1110, or a combination thereof. The image renderer 265 generates the rendered image 270 by rendering the 3D mesh 245 and/or the 3D model 255. In some examples, the image renderer 265 generates the rendered image 270 by rendering the 3D mesh 245 and/or the 3D model 255 from a specified perspective.

A graphic representing the image renderer 265 texture generator 250 is illustrated in FIG. 2, and illustrates a rendered image being generated from the graphic representing the 3D model 255. A graphic representing the rendered image 270 is illustrated in FIG. 2, and illustrates the rendered image based on the graphic representing the 3D model 255.

The sensor data processing system 200 includes output device(s) 260. The output device(s) 260 can include one or more visual output devices, such as display(s) or connector(s) therefor. The output device(s) 260 can include one or more audio output devices, such as speaker(s), headphone(s), and/or connector(s) therefor. The output device(s) 260 can include one or more of the output device 1135 and/or of the communication interface 1140 of the computing system 1100. In some examples, the sensor data processing system 200 causes the display(s) of the output device(s) 260 to display the 3D mesh 245, the 3D model 255, the texture for the 3D model 255, the rendered image 270, a portion or subset of any of these, or a combination thereof.

In some examples, the output device(s) 260 include one or more transceivers. The transceiver(s) can include wired transmitters, receivers, transceivers, or combinations thereof. The transceiver(s) can include wireless transmitters, receivers, transceivers, or combinations thereof. The transceiver(s) can include one or more of the output device 1135 and/or of the communication interface 1140 of the computing system 1100. In some examples, the sensor data processing system 200 causes the transceiver(s) to send, to a recipient device, the 3D mesh 245, the 3D model 255, the texture for the 3D model 255, the rendered image 270, a portion or subset of any of these, or a combination thereof. In some examples, the recipient device can include another sensor data processing system 200, an AMD 310, a mobile handset 410, a computing system 1100, or a combination thereof. In some examples, the recipient device can include a display, and the data sent to the recipient device from the transceiver(s) of the output device(s) 260 can cause the display of the recipient device to display the 3D mesh 245, the 3D model 255, the texture for the 3D model 255, the rendered image 270, a portion or subset of any of these, or a combination thereof.

In some examples, the display(s) of the output device(s) 260 of the sensor data processing system 200 function as optical “see-through” display(s) that allow light from the real-world environment (scene) around the sensor data processing system 200 to traverse (e.g., pass) through the display(s) of the output device(s) 260 to reach one or both eyes of the user. For example, the display(s) of the output device(s) 260 can be at least partially transparent, translucent, light-permissive, light-transmissive, or a combination thereof. In an illustrative example, the display(s) of the output device(s) 260 includes a transparent, translucent, and/or light-transmissive lens and a projector. The display(s) of the output device(s) 260 of can include a projector that projects virtual content (e.g., the 3D mesh 245, the 3D model 255, the texture for the 3D model 255, the rendered image 270, a portion or subset of any of these, or a combination thereof) onto the lens. The lens may be, for example, a lens of a pair of glasses, a lens of a goggle, a contact lens, a lens of a head-mounted display (HMD) device, or a combination thereof. Light from the real-world environment passes through the lens and reaches one or both eyes of the user. The projector can project virtual content (e.g., the 3D mesh 245, the 3D model 255, the texture for the 3D model 255, the rendered image 270, a portion or subset of any of these, or a combination thereof) onto the lens, causing the virtual content to appear to be overlaid over the user's view of the environment from the perspective of one or both of the user's eyes. In some examples, the projector can project the virtual content onto the onto one or both retinas of one or both eyes of the user rather than onto a lens, which may be referred to as a virtual retinal display (VRD), a retinal scan display (RSD), or a retinal projector (RP) display.

In some examples, the display(s) of the output device(s) 260 of the sensor data processing system 200 are digital “pass-through” display that allow the user of the sensor data processing system 200 and/or a recipient device to see a view of an environment by displaying the view of the environment on the display(s) of the output device(s) 260. The view of the environment that is displayed on the digital pass-through display can be a view of the real-world environment around the sensor data processing system 200, for example based on sensor data (e.g., images, videos, depth images, point clouds, other depth data, or combinations thereof) captured by the sensor 205 (e.g., sensor data 210) and/or other sensors described herein. The view of the environment that is displayed on the digital pass-through display can be a virtual environment (e.g., as in VR), which may in some cases include elements that are based on the real-world environment (e.g., boundaries of a room). The view of the environment that is displayed on the digital pass-through display can be an augmented environment (e.g., as in AR) that is based on the real-world environment. The view of the environment that is displayed on the digital pass-through display can be a mixed environment (e.g., as in MR) that is based on the real-world environment. The view of the environment that is displayed on the digital pass-through display can include virtual content (e.g., 3D mesh 245, the 3D model 255, the texture for the 3D model 255, the rendered image 270, a portion or subset of any of these, or a combination thereof) overlaid over other otherwise incorporated into the view of the environment.

Within FIG. 2, a graphic representing the output device(s) 260 illustrates a display, a speaker, and a wireless transceiver, outputting the graphic representing the rendered image 270.

The trained ML model(s) 280 can include one or more neural network (NNs) (e.g., neural network 900), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 2, a graphic representing the trained ML model(s) 280 illustrates a set of circles connected to another. Each of the circles can represent a node (e.g., node 916), a neuron, a perceptron, a layer, a portion thereof, or a combination thereof. The circles are arranged in columns. The leftmost column of white circles represent an input layer (e.g., input layer 910). The rightmost column of white circles represent an output layer (e.g., output layer 914). Two columns of shaded circled between the leftmost column of white circles and the rightmost column of white circles each represent hidden layers (e.g., hidden layers 912A-912N).

In some examples, the sensor data processing system 200 includes a feedback engine 285 of the sensor data processing system 200. The feedback engine 285 can detect feedback received from a user interface of the sensor data processing system 200. The feedback may include feedback on output(s) of the various subsystems of the sensor data processing system 200 (e.g., the sensor data processor 215, the target object tracker 220, the indicator object tracker 225, the 3D mesh generator 240, the texture generator 250, the output device(s) 260, the image renderer 265, and/or the trained ML model(s) 280), such as the target object detection/recognition/tracking, the indicator object detection/recognition/tracking, the target object outline 230, the indicator object movement path 235, the 3D mesh 245, the 3D model 255, the texture for the 3D model 255, the rendered image 270, a portion or subset of any of these, or a combination thereof. The feedback engine 285 can detect feedback about one engine of the sensor data processing system 200 received from another engine of the sensor data processing system 200, for instance whether one engine decides to use data from the other engine or not, and/or whether or not the use of that data is successful. The feedback received by the feedback engine 285 can be positive feedback or negative feedback. For instance, if the one engine of the sensor data processing system 200 uses data from another engine of the sensor data processing system 200 successfully, or if positive feedback from a user is received through a user interface, the feedback engine 285 can interpret this as positive feedback. If the one engine of the sensor data processing system 200 declines to data from another engine of the sensor data processing system 200, or is unable to successfully use the data from the other engine, or if negative feedback from a user is received through a user interface, the feedback engine 285 can interpret this as negative feedback. In an illustrative example, the feedback engine 285 can detect whether the 3D mesh generator 240 is able to successfully generate the 3D mesh 245 based on the target object outline 230 and/or the indicator object movement path 235. If so, the 3D mesh generator 240 effectively gives positive feedback to the target object tracker 220 and/or the indicator object tracker 225. If not, the 3D mesh generator 240 effectively gives negative feedback to the target object tracker 220 and/or the indicator object tracker 225.

Positive feedback can also be based on attributes of a user as detected in the sensor data 210 from the sensor(s) 205, such as the user smiling, laughing, nodding, saying a positive statement (e.g., “yes,” “confirmed,” “okay,” “next”), or otherwise positively reacting to an output of one of the engines described herein, or an indication thereof. Negative feedback can also be based on attributes of a user as detected in the sensor data from the sensor(s) 205, such as the user frowning, crying, shaking their head (e.g., in a “no” motion), saying a negative statement (e.g., “no,” “negative,” “bad,” “not this”), or otherwise negatively reacting to an output of one of the engines described herein, or an indication thereof.

In some examples, the feedback engine 285 provides the feedback to the trained ML model(s) 280 and/or to one or more subsystems of the sensor data processing system 200 that can use the trained ML model(s) 280 (e.g., the sensor data processor 215, the target object tracker 220, the indicator object tracker 225, the 3D mesh generator 240, the texture generator 250, and/or the image renderer 265) as training data to update the one or more trained ML model(s) 280 of the sensor data processing system 200. For instance, the feedback engine 285 can provide the feedback as training data to the ML system(s) and/or the trained ML model(s) 280 to update the training for the sensor data processor 215, the target object tracker 220, the indicator object tracker 225, the 3D mesh generator 240, the texture generator 250, the image renderer 265, the trained ML model(s) 280, or a combination thereof. Positive feedback can be used to strengthen and/or reinforce weights associated with the outputs of the ML system(s) and/or the trained ML model(s) 280, and/or to weaken or remove other weights other than those associated with the outputs of the ML system(s) and/or the trained ML model(s) 280. Negative feedback can be used to weaken and/or remove weights associated with the outputs of the ML system(s) and/or the trained ML model(s) 280, and/or to strengthen and/or reinforce other weights other than those associated with the outputs of the ML system(s) and/or the trained ML model(s) 280.

In some examples, certain elements of the sensor data processing system 200 (e.g., the sensor 205, the sensor data processor 215, the target object tracker 220, the indicator object tracker 225, the 3D mesh generator 240, the texture generator 250, the output device(s) 260, the image renderer 265, the trained ML model(s) 280, the feedback engine 285, or a combination thereof) include a software element, such as a set of instructions corresponding to a program, that is run on a processor such as the processor 1110 of the computing system 1100, the image processor 150, the host processor 152, the ISP 154, the sensor data processor 215, or a combination thereof. In some examples, one or more of these elements of the sensor data processing system 200 can include one or more hardware elements, such as a specialized processor (e.g., the processor 1110 of the computing system 1100, the image processor 150, the host processor 152, the ISP 154, the sensor data processor 215, or a combination thereof). In some examples, one or more of these elements of the sensor data processing system 200 can include a combination of one or more software elements and one or more hardware elements.

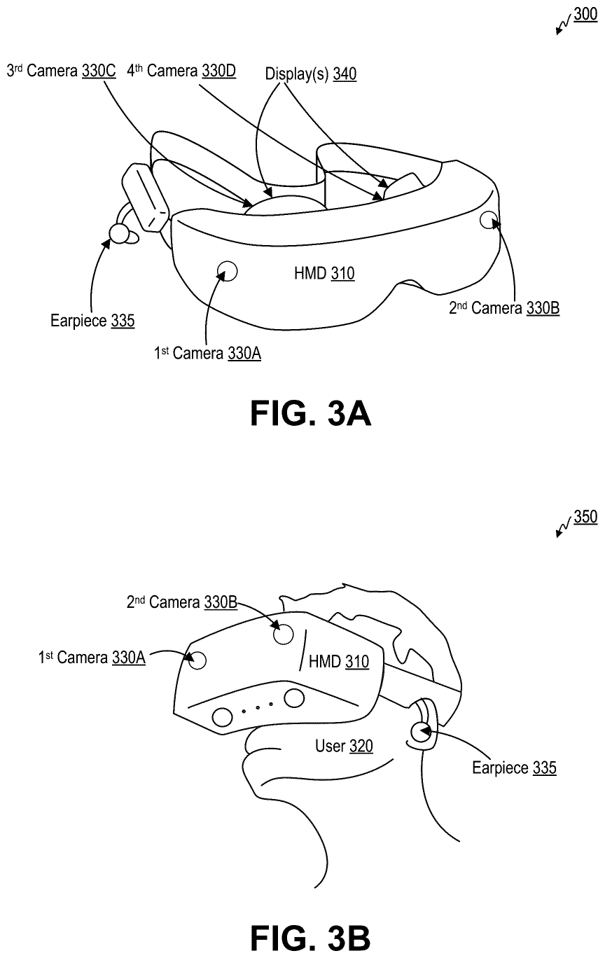

FIG. 3A is a perspective diagram 300 illustrating a head-mounted display (HMD) 310 that is used as part of a sensor data processing system 200. The HMD 310 may be, for example, an augmented reality (AR) headset, a virtual reality (VR) headset, a mixed reality (MR) headset, an extended reality (XR) headset, or some combination thereof. The HMD 310 may be an example of a sensor data processing system 200. The HMD 310 includes a first camera 330A and a second camera 330B along a front portion of the HMD 310. The first camera 330A and the second camera 330B may be examples of the sensor 205 of the sensor data processing system 200. The HMD 310 includes a third camera 330C and a fourth camera 330D facing the eye(s) of the user as the eye(s) of the user face the display(s) 340. The third camera 330C and the fourth camera 330D may be examples of the sensor 205 of the sensor data processing system 200. In some examples, the HMD 310 may only have a single camera with a single image sensor. In some examples, the HMD 310 may include one or more additional cameras in addition to the first camera 330A, the second camera 330B, third camera 330C, and the fourth camera 330D. In some examples, the HMD 310 may include one or more additional sensors in addition to the first camera 330A, the second camera 330B, third camera 330C, and the fourth camera 330D, which may also include other types of sensor 205 of the sensor data processing system 200. In some examples, the first camera 330A, the second camera 330B, third camera 330C, and/or the fourth camera 330D may be examples of the image capture and processing system 100, the image capture device 105A, the image processing device 105B, or a combination thereof.

The HMD 310 may include one or more displays 340 that are visible to a user 320 wearing the HMD 310 on the user 320's head. The one or more displays 340 of the HMD 310 can be examples of the one or more displays of the output device(s) 260 of the sensor data processing system 200. In some examples, the HMD 310 may include one display 340 and two viewfinders. The two viewfinders can include a left viewfinder for the user 320's left eye and a right viewfinder for the user 320's right eye. The left viewfinder can be oriented so that the left eye of the user 320 sees a left side of the display. The right viewfinder can be oriented so that the right eye of the user 320 sees a right side of the display. In some examples, the HMD 310 may include two displays 340, including a left display that displays content to the user 320's left eye and a right display that displays content to a user 320's right eye. The one or more displays 340 of the HMD 310 can be digital “pass-through” displays or optical “see-through” displays.

The HMD 310 may include one or more earpieces 335, which may function as speakers and/or headphones that output audio to one or more ears of a user of the HMD 310, and may be examples of output device(s) 260. One earpiece 335 is illustrated in FIGS. 3A and 3B, but it should be understood that the HMD 310 can include two earpieces, with one earpiece for each ear (left ear and right ear) of the user. In some examples, the HMD 310 can also include one or more microphones (not pictured). In some examples, the audio output by the HMD 310 to the user through the one or more earpieces 335 may include, or be based on, audio recorded using the one or more microphones.

FIG. 3B is a perspective diagram 350 illustrating the head-mounted display (HMD) of FIG. 3A being worn by a user 320. The user 320 wears the HMD 310 on the user 320's head over the user 320's eyes. The HMD 310 can capture images with the first camera 330A and the second camera 330B. In some examples, the HMD 310 displays one or more output images toward the user 320's eyes using the display(s) 340. In some examples, the output images can include the 3D mesh 245, the 3D model 255, the texture for the 3D model 255, the rendered image 270, a portion or subset of any of these, or a combination thereof. The output images can be based on the images captured by the first camera 330A and the second camera 330B (e.g., the sensor data 210), for example with the virtual content (e.g., the 3D mesh 245, the 3D model 255, the texture for the 3D model 255, the rendered image 270, a portion or subset of any of these, or a combination thereof) overlaid. The output images may provide a stereoscopic view of the environment, in some cases with the virtual content overlaid and/or with other modifications. For example, the HMD 310 can display a first display image to the user 320's right eye, the first display image based on an image captured by the first camera 330A. The HMD 310 can display a second display image to the user 320's left eye, the second display image based on an image captured by the second camera 330B. For instance, the HMD 310 may provide overlaid virtual content in the display images overlaid over the images captured by the first camera 330A and the second camera 330B. The third camera 330C and the fourth camera 330D can capture images of the eyes of the before, during, and/or after the user views the display images displayed by the display(s) 340. This way, the sensor data from the third camera 330C and/or the fourth camera 330D can capture reactions to the virtual content by the user's eyes (and/or other portions of the user). An earpiece 335 of the HMD 310 is illustrated in an ear of the user 320. The HMD 310 may be outputting audio to the user 320 through the earpiece 335 and/or through another earpiece (not pictured) of the HMD 310 that is in the other ear (not pictured) of the user 320.

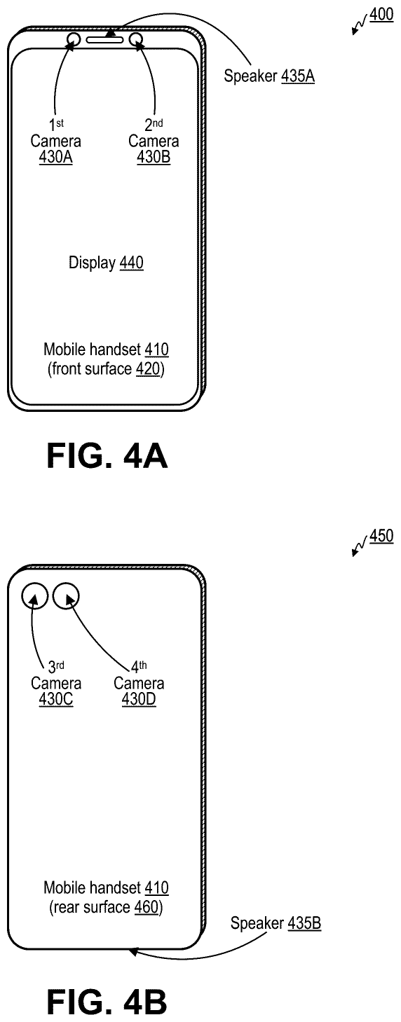

FIG. 4A is a perspective diagram 400 illustrating a front surface of a mobile handset 410 that includes front-facing cameras and can be used as part of a sensor data processing system 200. The mobile handset 410 may be an example of a sensor data processing system 200. The mobile handset 410 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 420 of the mobile handset 410 includes a display 440. The front surface 420 of the mobile handset 410 includes a first camera 430A and a second camera 430B. The first camera 430A and the second camera 430B may be examples of the sensor 205 of the sensor data processing system 200. The first camera 430A and the second camera 430B can face the user, including the eye(s) of the user, while content (e.g., the 3D mesh 245, the 3D model 255, the texture for the 3D model 255, the rendered image 270, a portion or subset of any of these, or a combination thereof) is displayed on the display 440. The display 440 may be an example of the display(s) of the output device(s) 260 of the sensor data processing system 200.

The first camera 430A and the second camera 430B are illustrated in a bezel around the display 440 on the front surface 420 of the mobile handset 410. In some examples, the first camera 430A and the second camera 430B can be positioned in a notch or cutout that is cut out from the display 440 on the front surface 420 of the mobile handset 410. In some examples, the first camera 430A and the second camera 430B can be under-display cameras that are positioned between the display 440 and the rest of the mobile handset 410, so that light passes through a portion of the display 440 before reaching the first camera 430A and the second camera 430B. The first camera 430A and the second camera 430B of the perspective diagram 400 are front-facing cameras. The first camera 430A and the second camera 430B face a direction perpendicular to a planar surface of the front surface 420 of the mobile handset 410. The first camera 430A and the second camera 430B may be two of the one or more cameras of the mobile handset 410. In some examples, the front surface 420 of the mobile handset 410 may only have a single camera.

In some examples, the display 440 of the mobile handset 410 displays one or more output images toward the user using the mobile handset 410. In some examples, the output images can include the 3D mesh 245, the 3D model 255, the texture for the 3D model 255, the rendered image 270, a portion or subset of any of these, or a combination thereof. The output images can be based on the images (e.g., the sensor data 210) captured by the first camera 430A, the second camera 430B, the third camera 430C, and/or the fourth camera 430D, for example with the virtual content (e.g., the 3D mesh 245, the 3D model 255, the texture for the 3D model 255, the rendered image 270, a portion or subset of any of these, or a combination thereof) overlaid.

In some examples, the front surface 420 of the mobile handset 410 may include one or more additional cameras in addition to the first camera 430A and the second camera 430B. The one or more additional cameras may also be examples of the sensor 205 of the sensor data processing system 200. In some examples, the front surface 420 of the mobile handset 410 may include one or more additional sensors in addition to the first camera 430A and the second camera 430B. The one or more additional sensors may also be examples of the sensor 205 of the sensor data processing system 200. In some cases, the front surface 420 of the mobile handset 410 includes more than one display 440. The one or more displays 440 of the front surface 420 of the mobile handset 410 can be examples of the display(s) of the output device(s) 260 of the sensor data processing system 200. For example, the one or more displays 440 can include one or more touchscreen displays.

The mobile handset 410 may include one or more speakers 435A and/or other audio output devices (e.g., earphones or headphones or connectors thereto), which can output audio to one or more ears of a user of the mobile handset 410. One speaker 435A is illustrated in FIG. 4A, but it should be understood that the mobile handset 410 can include more than one speaker and/or other audio device. In some examples, the mobile handset 410 can also include one or more microphones (not pictured). In some examples, the mobile handset 410 can include one or more microphones along and/or adjacent to the front surface 420 of the mobile handset 410, with these microphones being examples of the sensor 205 of the sensor data processing system 200. In some examples, the audio output by the mobile handset 410 to the user through the one or more speakers 435A and/or other audio output devices may include, or be based on, audio recorded using the one or more microphones.

FIG. 4B is a perspective diagram 450 illustrating a rear surface 460 of a mobile handset that includes rear-facing cameras and that can be used as part of a sensor data processing system 200. The mobile handset 410 includes a third camera 430C and a fourth camera 430D on the rear surface 460 of the mobile handset 410. The third camera 430C and the fourth camera 430D of the perspective diagram 450 are rear-facing. The third camera 430C and the fourth camera 430D may be examples of the sensor 205 of the sensor data processing system 200. The third camera 430C and the fourth camera 430D face a direction perpendicular to a planar surface of the rear surface 460 of the mobile handset 410.

The third camera 430C and the fourth camera 430D may be two of the one or more cameras of the mobile handset 410. In some examples, the rear surface 460 of the mobile handset 410 may only have a single camera. In some examples, the rear surface 460 of the mobile handset 410 may include one or more additional cameras in addition to the third camera 430C and the fourth camera 430D. The one or more additional cameras may also be examples of the sensor 205 of the sensor data processing system 200. In some examples, the rear surface 460 of the mobile handset 410 may include one or more additional sensors in addition to the third camera 430C and the fourth camera 430D. The one or more additional sensors may also be examples of the sensor 205 of the sensor data processing system 200. In some examples, the first camera 430A, the second camera 430B, third camera 430C, and/or the fourth camera 430D may be examples of the image capture and processing system 100, the image capture device 105A, the image processing device 105B, or a combination thereof.

The mobile handset 410 may include one or more speakers 435B and/or other audio output devices (e.g., earphones or headphones or connectors thereto), which can output audio to one or more ears of a user of the mobile handset 410. One speaker 435B is illustrated in FIG. 4B, but it should be understood that the mobile handset 410 can include more than one speaker and/or other audio device. In some examples, the mobile handset 410 can also include one or more microphones (not pictured). In some examples, the mobile handset 410 can include one or more microphones along and/or adjacent to the rear surface 460 of the mobile handset 410, with these microphones being examples of the sensor 205 of the sensor data processing system 200. In some examples, the audio output by the mobile handset 410 to the user through the one or more speakers 435B and/or other audio output devices may include, or be based on, audio recorded using the one or more microphones.

The mobile handset 410 may use the display 440 on the front surface 420 as a pass-through display. For instance, the display 440 may display output images, such as the 3D mesh 245, the 3D model 255, the texture for the 3D model 255, the rendered image 270, a portion or subset of any of these, or a combination thereof. The output images can be based on the images (e.g. the sensor data 210) captured by the third camera 430C and/or the fourth camera 430D, for example with the virtual content (e.g., the 3D mesh 245, the 3D model 255, the texture for the 3D model 255, the rendered image 270, a portion or subset of any of these, or a combination thereof) overlaid. The first camera 430A and/or the second camera 430B can capture images of the user's eyes (and/or other portions of the user) before, during, and/or after the display of the output images with the virtual content on the display 440. This way, the sensor data from the first camera 430A and/or the second camera 430B can capture reactions to the virtual content by the user's eyes (and/or other portions of the user).

FIG. 5 is a conceptual diagram illustrating a modeling process 500 for generation of a three-dimensional model of a target object (a can) based on tracking of a movement path of an indicator object (a user's finger) relative to the target object. The modeling process 500 is an additive process, and is illustrated in stages. At each stage, a real-world depiction of a scene (e.g., as captured in sensor data 210 from a sensor 205) is illustrated under the title “real world,” and virtual data corresponding to what is happening in the real-world scene is also illustrated under the title “virtual world.” The virtual data can include, for instance, at least a portion of the target object outline 230, at least a portion of the indicator object movement path 235, at least a portion of the 3D mesh 245, and/or at least a portion of the 3D model 255.

At all stages, a target object—a can—is illustrated in an environment in the real world. At stage 505, in the real world, a user points a finger at an edge of the target object (the can). The fingertip of the user's finger is the indicator object for the modeling process 500. At stage 505, the fingertip is illustrated (using arrows) moving downward along an edge of the target object, tracing the edge of the target object. At stage 505, in the virtual world, the path of the fingertip (e.g., the indicator object movement path 235 tracing the target object outline 230) is illustrated as it begins to form. The perspective of the target object in the sensor data (the real world) determines what edges are discernable to trace, and can therefore impact the indicator object movement path 235 and/or the target object outline 230 that are generated in the virtual world.

At stage 510 and stage 515, in the real world, the fingertip is illustrated (using arrows) continuing to trace edges of the target object. At stage 510 and stage 515, in the virtual world, the path of the fingertip (e.g., the indicator object movement path 235 tracing the target object outline 230) is illustrated. In some examples, the indicator object movement path 235 may snap to the nearest portion of the target object outline 230 to compensate for shakiness or unwanted movement(s) in the indicator object (e.g., in the fingertip). At stage 515, in the virtual world, all of the edges of the target object has been traced, and an untextured 3D mesh (e.g., the 3D mesh 245) representing the target object is generated (e.g., by the 3D mesh generator 240).

At stage 520, the fingertip is no longer illustrated in the real world, indicating that the fingertip is no longer in the scene and/or that the generation of the indicator object movement path 235 is complete. At stage 520, in the virtual world, a texture is generated (e.g., by the texture generator 250) based on the depiction of the target object (the can) in the real world, and is applied to the 3D mesh, to generate a 3D model 255 of the target object (the can).

The modeling process 500 illustrated in FIG. 5 is additive, since the 3D volume generated (e.g., by the 3D mesh generator 240) based on the indicator object movement path 235 and/or the target object outline 230 becomes the 3D mesh 245 of the target object (the can), and ultimately becomes the 3D model 255 of the target object. In some examples, a user may generate an additional 3D volume to add to the 3D mesh 245 and/or to the 3D model 255 of the target object of FIG. 5.

FIG. 6 is a conceptual diagram illustrating a first modeling process 600 for subtractive generation of a three-dimensional model of a target object (a person) based on tracking of a movement path of an indicator object (a user's finger) relative to the target object. The modeling process 600 is a subtractive process, and is illustrated in stages. At each stage, a real-world depiction of a scene (e.g., as captured in sensor data 210 from a sensor 205) is illustrated under the title “real world,” and virtual data corresponding to what is happening in the real-world scene is also illustrated under the title “virtual world.” The virtual data can include, for instance, at least a portion of the target object outline 230, at least a portion of the indicator object movement path 235, at least a portion of the 3D mesh 245, and/or at least a portion of the 3D model 255.

At all stages, a target object—a bust of a person—is illustrated in an environment in the real world. At stage 605, in the real world, the target object (the bust) is illustrated without any indicator object, and in the virtual world, a pre-generated 3D mesh of a 3D block (e.g., a cube) is illustrated. At stage 610, in the real world, a user points a finger at an edge of the target object (the bust). The fingertip of the user's finger is the indicator object for the modeling processes 600 and 700. At stage 610, the fingertip is illustrated (using a dashed line) moving downward along an edge of the target object, tracing the edge of the target object. At stage 610, in the virtual world, a 3D volume whose shape is projected based on the path of the fingertip (e.g., the indicator object movement path 235 tracing the target object outline 230) is illustrated being removed, subtracted from, or carved out of the pre-generated 3D mesh (the 3D block from stage 605). The perspective of the target object in the sensor data (the real world) determines the shape of the edge that is traced, and therefore impacts the shape of the 3D volume that is removed from the pre-generated 3D mesh.

At stage 615, in the real world, the fingertip completes the tracing of the edge of the target object all around the exterior of the target object. At stage 615, in the virtual world, a 3D volume whose shape is projected based on the path of the fingertip (e.g., the indicator object movement path 235 tracing the target object outline 230) is illustrated being removed, subtracted from, or carved out of the pre-generated 3D mesh (the 3D block from stage 605 and/or the intermediate 3D mesh of stage 610).

At stage 620, in the real world, the perspective on the target object is rotated by 90 degrees, for instance by rotating the target object itself, by moving the sensor 205 relative to the target object, or a combination thereof. At stage 620, in the virtual world, the 3D mesh remains as it was in stage 615. At stage 625, in the real world, the fingertip is illustrated (using a dashed line) moving downward along an edge of the target object, tracing the edge of the target object. Because of the change in perspective, the edge of the target object traced at stage 625 is a different edge than the edge of the of the target object that was traced at stages 610 and 615. At stage 625, in the virtual world, a 3D volume whose shape is projected based on the path of the fingertip (e.g., the indicator object movement path 235 tracing the target object outline 230) is illustrated being removed, subtracted from, or carved out of the pre-generated 3D mesh (the intermediate 3D mesh of stages 615 and 620).

At stage 630, in the real world, the fingertip completes the tracing of the edge of the target object all around the exterior of the target object. At stage 630, in the virtual world, a 3D volume whose shape is projected based on the path of the fingertip (e.g., the indicator object movement path 235 tracing the target object outline 230) is illustrated being removed, subtracted from, or carved out of the pre-generated 3D mesh (the intermediate 3D mesh of stages 615, 620, and/or 625).

FIG. 7 is a conceptual diagram illustrating a second modeling process 700 for subtractive generation of a three-dimensional model of a target object (a person) based on tracking of a movement path of an indicator object (a user's finger) relative to the target object. The second modeling process 700 of FIG. 7 is a continuation of the first modeling process 600 of FIG. 6.

At stage 705, in the real world, the perspective on the target object is rotated by 45 degrees, for instance by rotating the target object itself, by moving the sensor 205 relative to the target object, or a combination thereof. At stage 705, in the virtual world, the 3D mesh remains as it was in stage 630. At stage 710, in the real world, the fingertip is illustrated (using a dashed line) moving downward along an edge of the target object, tracing the edge of the target object. Because of the change in perspective, the edge of the target object traced at stage 710 is a different edge than the edges of the of the target object that were traced at stages 610, 615, 625, and 630. At stage 710, in the virtual world, a 3D volume whose shape is projected based on the path of the fingertip (e.g., the indicator object movement path 235 tracing the target object outline 230) is illustrated being removed, subtracted from, or carved out of the pre-generated 3D mesh (the intermediate 3D mesh of stages 615 and 620).

At stage 715, in the real world, the fingertip completes the tracing of the edge of the target object by connecting an end point of the path of the fingertip to the start point of the path of the fingertip. At stage 715, in the virtual world, a 3D volume whose shape is projected based on the path of the fingertip (e.g., the indicator object movement path 235 tracing the target object outline 230) is illustrated being removed, subtracted from, or carved out of the pre-generated 3D mesh (the intermediate 3D mesh of stages 630, 705, and/or 710). This refines the curvature and/or contours of the target object in the 3D mesh. At stage 720, in the real world, the perspective on the target object is rotated slightly, for instance by rotating the target object itself, by moving the sensor 205 relative to the target object, or a combination thereof. At stage 720, in the virtual world, the 3D mesh is completed, with refinements performed in stage 715 completed.

At stage 725, in the real world, the perspective on the target object is rotated slightly again, for instance by rotating the target object itself, by moving the sensor 205 relative to the target object, or a combination thereof. At stage 725, in the virtual world, a texture is generated (e.g., by the texture generator 250) based on the depiction of the target object (the bust) in the real world, and is applied to the 3D mesh, to generate a 3D model 255 of the target object (the bust).

The modeling processes 600 and 700 illustrated in FIGS. 6-7 are subtractive, since the 3D volumes generated (e.g., by the 3D mesh generator 240) based on the indicator object movement path 235 and/or the target object outline 230 is removed from a previous 3D mesh, starting from the block in the virtual world at stage 605 and iterating further. In some examples, some stages and/or portions of the modeling processes 600 and 700 illustrated in FIGS. 6-7 may be additive. For instance, some of the refinements of the face of the target object (the bust) in the 3D mesh illustrated in stages 715 and 720 may add some 3D volumes to the face relative to the pre-generated 3D mesh (the intermediate 3D mesh of stag 710 and/or 715).

FIG. 8 is a conceptual diagram illustrating a modeling process 800 for generation of a three-dimensional model of a target object (a ball) based on tracking of movement(s) of the target object and/or an indicator object (a user's hand) relative to the target object. The modeling process 800 is an additive process, and is illustrated in stages. At each stage, a real-world depiction of a scene (e.g., as captured in sensor data 210 from a sensor 205) is illustrated under the title “real world,” and virtual data corresponding to what is happening in the real-world scene is also illustrated under the title “virtual world.” The virtual data can include, for instance, at least a portion of the target object outline 230, at least a portion of the indicator object movement path 235, at least a portion of the 3D mesh 245, and/or at least a portion of the 3D model 255.

At all stages, a target object—a ball—is illustrated in an environment in the real world. At stage 805, in the real world, a user grasps the target object (the ball) in the user's hand. The user's hand is the indicator object in the modeling process 800. At stage 805, the shape of user's hand cradles the shape of the ball, effectively tracing certain edge(s) of the ball with the shape of the user's hand. At stage 805, in the virtual world, key points along the surface of the target object (the ball) are illustrated as circles with solid outlines, and representations of some of the fingers on the user's hand are illustrated in dashed lines.

At stages 810, 815, 820, 825, and 830, in the real world, the perspective on the target object (the ball) changes based on movements of the user's hand as the user's hand holds and/or grips the target object, based on movements of the sensor 205, or a combination thereof. At stages 810, 815, 820, 825, and 830, in the virtual world, more and more key points along the surface of the ball are captured, and 3D mesh of the ball (illustrated using areas shaded with a mottled pattern) gradually forms and additively increases in size to eventually cover the entirety of the ball in stage 830. The movements of the user's hand can be tracked by the indicator object tracker 225 as the indicator object movement path 235. The outline of the ball can be tracked by the target object tracker as the target object outline 230, and slowly forms and evolves based on different perspectives on the ball and the user's hand over the course of stages 805 to 830.

At stages 835 and 840, the hand is no longer illustrated in the real world, indicating that the hand is no longer in the scene and/or that the generation of the indicator object movement path 235 is complete. At stage 835, in the virtual world, the 3D mesh of the target object (the ball) is complete. At stage 840, in the virtual world, a texture is generated (e.g., by the texture generator 250) based on the depiction of the target object (the ball) in the real world, and is applied to the 3D mesh, to generate a 3D model 255 of the target object (the ball).

The modeling process 800 illustrated in FIG. 8 is additive, since the 3D volume generated (e.g., by the 3D mesh generator 240) based on the indicator object movement path 235 and/or the target object outline 230 becomes the 3D mesh 245 of the target object (the ball), and ultimately becomes the 3D model 255 of the target object. In some examples, a user may generate an additional 3D volume to add to the 3D mesh 245 and/or to the 3D model 255 of the target object of FIG. 8.

The modeling process 800 illustrated in FIG. 8 is additive, since the 3D volume generated (e.g., by the 3D mesh generator 240) based on the indicator object movement path 235 and/or the target object outline 230 becomes the 3D mesh 245 of the target object (the ball), and ultimately becomes the 3D model 255 of the target object. In some examples, a user may generate an additional 3D volume to add to the 3D mesh 245 and/or to the 3D model 255 of the target object of FIG. 8.

In some examples, a modeling process such as the modeling processes 500, 600, 700, or 800 can be started using a certain trigger condition. For instance, in an illustrative example, a trigger condition can be both hands of the user entering the field of view of the sensor 205 (e.g., and thus appearing in the sensor data 210). In a second illustrative example, a trigger condition can be an audio command spoken by the user, recorded by the sensor 205, and recognized by the sensor data processing system 200. In a third illustrative example, a trigger condition can be a press of a button, a flip of a switch, or another change in a user interface (e.g., via an input device 1145) detected at the sensor data processing system 200.

In some examples, a modeling process such as the modeling processes 500, 600, 700, or 800 can combine respective portions of different real-world objects into one 3D mesh 245 and/or 3D model 255 in the real world. For instance, a 3D mesh and/or 3D model 255 can be generated to include first part of one real-world object (e.g., a part of the can of FIG. 5), a second part of a second real-world object (e.g., a part of the bust of FIGS. 6-7), a third part of a third real-world object (e.g., a part of the ball of FIG. 8), and so on, all combined according to a arrangement that is specified by the user, by the sensor data processing system 200 (e.g., based on how the shapes of these parts best fit together), by the NN 900, or a combination thereof.

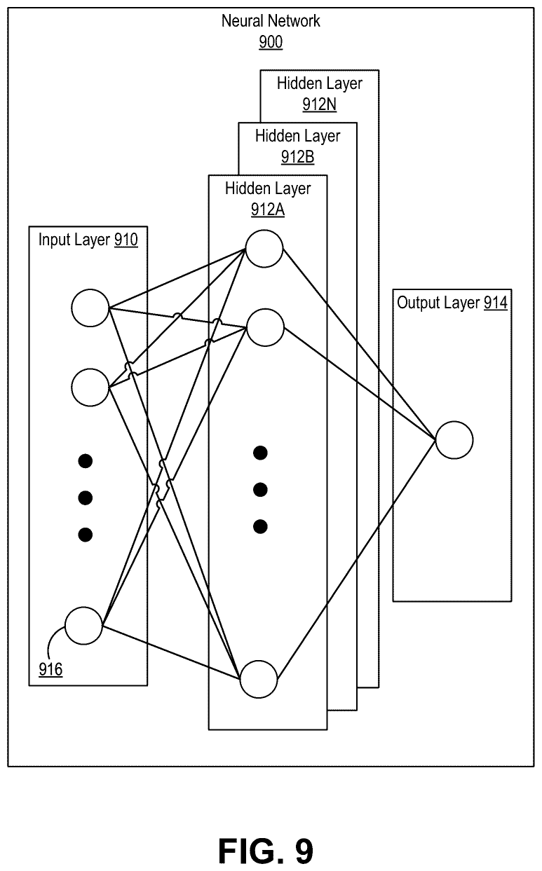

FIG. 9 is a block diagram illustrating an example of a neural network (NN) 900 that can be used for object tracking and three-dimensional modeling operations. The neural network 900 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 900 may be an example of the trained ML model(s) 280. The neural network 900 may used by various subsystems of the sensor data processing system 200, such as the sensor data processor 215, the target object tracker 220, the indicator object tracker 225, the 3D mesh generator 240, the texture generator 250, the output device(s) 260, and/or the image renderer 265.

An input layer 910 of the neural network 900 includes input data. The input data of the input layer 910 can include data representing the pixels of one or more input image frames. In some examples, the input data of the input layer 910 includes data representing the pixels of image data. Examples of the image data include an image captured using the image capture and processing system 100, the sensor data 210, an image captured by one of the cameras 330A-330D, an image captured by one of the cameras 430A-430D, any of the image(s) of the real world in FIGS. 5-8, the image data of operation 1005, and/or an image captured using the input device 1145, any other image data described herein, any other sensor data described herein, or a combination thereof. The input data in the input layer 910 can also include other data, such as data corresponding to the target object detection/recognition/tracking by the target object tracker 220, the indicator object detection/recognition/tracking by the indicator object tracker 225, the target object outline 230, the indicator object movement path 235, the 3D mesh 245, the 3D model 255, the texture for the 3D model 255, the rendered image 270, a portion or subset of any of these, or a combination thereof.

The images can include image data from an image sensor including raw pixel data (including a single color per pixel based, for example, on a Bayer filter) or processed pixel values (e.g., RGB pixels of an RGB image). The neural network 900 includes multiple hidden layers 912, 912B, through 912N. The hidden layers 912, 912B, through 912N include “N” number of hidden layers, where “N” is an integer greater than or equal to one. The number of hidden layers can be made to include as many layers as needed for the given application. The neural network 900 further includes an output layer 914 that provides an output resulting from the processing performed by the hidden layers 912, 912B, through 912N.

The output layer 914 can provide output data for an operation performed using the NN 900. For instance, the output layer 914 can provide output data such as the data corresponding to the target object detection/recognition/tracking by the target object tracker 220, the indicator object detection/recognition/tracking by the indicator object tracker 225, the target object outline 230, the indicator object movement path 235, the 3D mesh 245, the 3D model 255, the texture for the 3D model 255, the rendered image 270, a portion or subset of any of these, or a combination thereof.

The neural network 900 is a multi-layer neural network of interconnected filters. Each filter can be trained to learn a feature representative of the input data. Information associated with the filters is shared among the different layers and each layer retains information as information is processed. In some cases, the neural network 900 can include a feed-forward network, in which case there are no feedback connections where outputs of the network are fed back into itself. In some cases, the network 900 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 910 can activate a set of nodes in the first hidden layer 912A. For example, as shown, each of the input nodes of the input layer 910 can be connected to each of the nodes of the first hidden layer 912A. The nodes of a hidden layer can transform the information of each input node by applying activation functions (e.g., filters) to this information. The information derived from the transformation can then be passed to and can activate the nodes of the next hidden layer 912B, which can perform their own designated functions. Example functions include convolutional functions, downscaling, upscaling, data transformation, and/or any other suitable functions. The output of the hidden layer 912B can then activate nodes of the next hidden layer, and so on. The output of the last hidden layer 912N can activate one or more nodes of the output layer 914, which provides a processed output image. In some cases, while nodes (e.g., node 916) in the neural network 900 are shown as having multiple output lines, a node has a single output and all lines shown as being output from a node represent the same output value.

In some cases, each node or interconnection between nodes can have a weight that is a set of parameters derived from the training of the neural network 900. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 910 using the different hidden layers 912, 912B, through 912N in order to provide the output through the output layer 914.

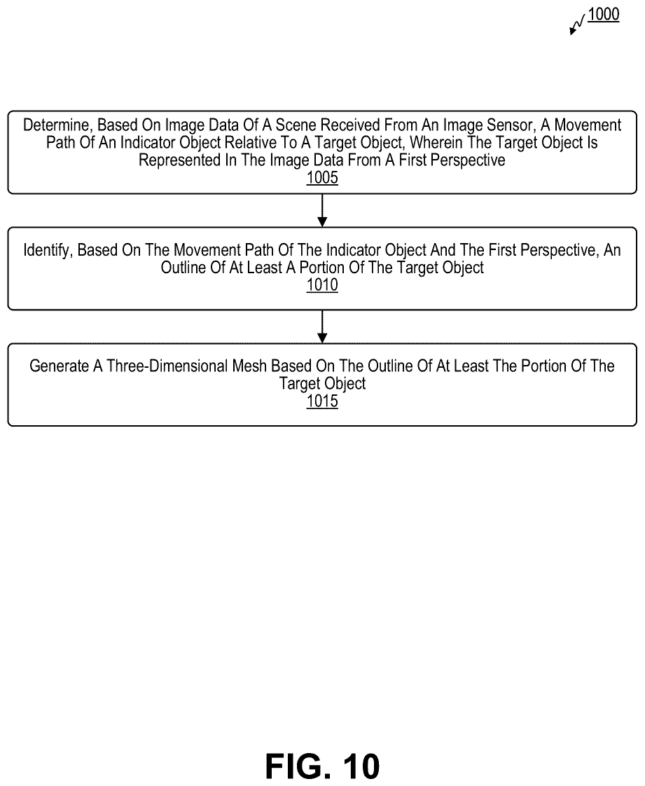

FIG. 10 is a flow diagram illustrating a process 1000 for three-dimensional modeling based on object tracking. The process 1000 may be performed by a sensor data processing system. In some examples, the sensor data processing system can include, for example, the image capture and processing system 100, the image capture device 105A, the image processing device 105B, the image processor 150, the ISP 154, the host processor 152, the sensor data processing system 200, the neural network 900, the computing system 1100, the processor 1110, or a combination thereof. In some examples, the sensor data processing system includes a display. In some examples, the imaging system includes a transceiver.

At operation 1005, the sensor data processing system is configured to, and can, determine, based on image data of a scene received from an image sensor, a movement path of an indicator object relative to a target object. The target object is represented in the image data from a first perspective. In some aspects, the sensor data processing system may detect, based on the image data and previous image data of the scene, a change from a second perspective to the first perspective (e.g., as described previously with respect to FIG. 6, FIG. 7, and FIG. 8). In such aspects, the target object may be represented in the previous image data from the second perspective. The previous image data may be received from the image sensor before the image data. In some cases, the sensor data processing system may track a hand in the image data to determine the movement path of the indicator object relative to the target object. In such cases, the indicator object may include at least a portion of the hand. In some examples, the target object is held by the hand. In some examples, the movement path of the indicator object is configured to rotate the target object.

Examples of the image sensor includes the image sensor 130, the sensor(s) 205, the first camera 330A, the second camera 330B, the third camera 330C, the fourth camera 330D, the first camera 430A, the second camera 430B, the third camera 430C, the fourth camera 430D, an image sensor used to capture an image used as input data for the input layer 910 of the NN 900, the input device 1145, another image sensor described herein, another sensor described herein, or a combination thereof. Examples of the raw image data includes the raw image data 210.

At operation 1010, the sensor data processing system is configured to, and can, identify, based on the movement path of the indicator object and the first perspective, an outline of at least a portion of the target object.

At operation 1015, the sensor data processing system is configured to, and can, generate a three-dimensional mesh based on the outline of at least the portion of the target object. In some aspects, the sensor data processing system may remove a portion of a previous three-dimensional mesh to generate the three-dimensional mesh. In such aspects, the portion of the previous three-dimensional mesh may be based on the outline of at least the portion of the target object. Additionally or alternatively, in some examples, the sensor data processing system may combine a volume with the previous three-dimensional mesh (or a different previous three-dimensional mesh) to generate the three-dimensional mesh. In such examples, the volume combined with the previous three-dimensional mesh may be based on the outline of at least the portion of the target object. Additionally or alternatively, in some cases, the sensor data processing system may apply a texture to the three-dimensional mesh to generate a three-dimensional model. For example, the texture may be based on a representation of the target object in the image data. In some aspects, the texture may be generated by the texture generator 250 described above. In some cases, the sensor data processing system may generate a shape of an edge of the three-dimensional mesh to match a shape of the outline of at least the portion of the target object (e.g., as described previously with respect to FIG. 6).

In some aspects, the sensor data processing system may determine, based on second image data of the scene received from the image sensor, a second movement path of the indicator object relative to the target object. In some aspects, the target object is represented in the second image data from the first perspective. In such aspects, the sensor data processing system may identify, based on the second movement path of the indicator object and the first perspective, a second outline of at least a second portion of the target object. In some cases, the target object is represented in the second image data from a second perspective. In such cases, the sensor data processing system may identify, based on the second movement path of the indicator object and the second perspective, a second outline of at least a second portion of the target object. In either of the aspects or cases, the three-dimensional mesh may also be generated based on the second outline of at least the second portion of the target object. In some cases, a shape of a first edge of the three-dimensional mesh is generated to match a shape of the outline of at least the portion of the target object, and a shape of a second edge of the three-dimensional mesh is generated to match a shape of the second outline of at least the second portion of the target object.

In some examples, the processes described herein (e.g., the respective processes of FIGS. 1, 2, 5, 6, 7, 8, 9, the process 1000 of FIG. 10, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the sensor data processing system 200, the neural network 900, the sensor data processing system that performs the process 1000, the computing system 1100, the processor 1110, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

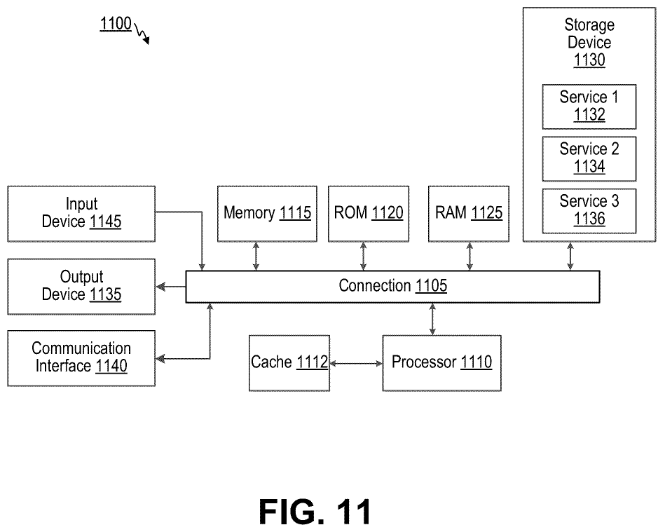

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 1102.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image-based modeling, the apparatus comprising: at least one memory; and at least one processor coupled to the at least one memory and configured to: determine, based on image data of a scene received from an image sensor, a movement path of an indicator object relative to a target object, wherein the target object is represented in the image data from a first perspective; identify, based on the movement path of the indicator object and the first perspective, an outline of at least a portion of the target object; and generate a three-dimensional mesh based on the outline of at least the portion of the target object.

Aspect 2. The apparatus of Aspect 1, wherein the at least one processor is configured to: apply a texture to the three-dimensional mesh to generate a three-dimensional model, wherein the texture is based on a representation of the target object in the image data.

Aspect 3. The apparatus of any of Aspects 1 to 2, wherein the at least one processor is configured to: track a hand in the image data to determine the movement path of the indicator object relative to the target object, wherein the indicator object includes at least a portion of the hand.

Aspect 4. The apparatus of Aspect 3, wherein the target object is held by the hand, and wherein the movement path of the indicator object is configured to rotate the target object.

Aspect 5. The apparatus of any of Aspects 1 to 4, wherein the at least one processor is configured to: remove a portion of a previous three-dimensional mesh to generate the three-dimensional mesh, wherein the portion of the previous three-dimensional mesh is based on the outline of at least the portion of the target object.

Aspect 6. The apparatus of any of Aspects 1 to 5, wherein the at least one processor is configured to: combine a volume with a previous three-dimensional mesh to generate the three-dimensional mesh, wherein the volume combined with the previous three-dimensional mesh is based on the outline of at least the portion of the target object.

Aspect 7. The apparatus of any of Aspects 1 to 6, wherein the at least one processor is configured to: detect, based on the image data and previous image data of the scene, a change from a second perspective to the first perspective, wherein the target object is represented in the previous image data from the second perspective, wherein the previous image data is received from the image sensor before the image data.

Aspect 8. The apparatus of any of Aspects 1 to 7, wherein the at least one processor is configured to generate a shape of an edge of the three-dimensional mesh to match a shape of the outline of at least the portion of the target object.

Aspect 9. The apparatus of any of Aspects 1 to 8, wherein the at least one processor is configured to: determine, based on second image data of the scene received from the image sensor, a second movement path of the indicator object relative to the target object, wherein the target object is represented in the second image data from the first perspective; and identify, based on the second movement path of the indicator object and the first perspective, a second outline of at least a second portion of the target object, wherein the three-dimensional mesh is generated also based on the second outline of at least the second portion of the target object.

Aspect 10. The apparatus of Aspect 9, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

Aspect 11. The apparatus of any of Aspects 1 to 10, wherein the at least one processor is configured to: determine, based on second image data of the scene received from the image sensor, a second movement path of the indicator object relative to the target object, wherein the target object is represented in the second image data from a second perspective; and identify, based on the second movement path of the indicator object and the second perspective, a second outline of at least a second portion of the target object, wherein the three-dimensional mesh is generated also based on the second outline of at least the second portion of the target object.

Aspect 12. The apparatus of Aspect 11, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

Aspect 13. The apparatus of any of Aspects 1 to 12, further comprising: the image sensor.

Aspect 14. The apparatus of any of Aspects 1 to 13, further comprising: a display configured to display the three-dimensional mesh.

Aspect 15. The apparatus of any of Aspects 1 to 14, further comprising: a communication transceiver configured to transmit the three-dimensional mesh to a recipient device.

Aspect 16. The apparatus of any of Aspects 1 to 15, wherein the apparatus includes at least one of a head-mounted display (HMD), a mobile handset, or a wireless communication device.

Aspect 17. A method of image-based modeling, the method comprising: determining, based on image data of a scene received from an image sensor, a movement path of an indicator object relative to a target object, wherein the target object is represented in the image data from a first perspective; identifying, based on the movement path of the indicator object and the first perspective, an outline of at least a portion of the target object; and generating a three-dimensional mesh based on the outline of at least the portion of the target object.

Aspect 18. The method of Aspect 17, further comprising: applying a texture to the three-dimensional mesh to generate a three-dimensional model, wherein the texture is based on a representation of the target object in the image data.

Aspect 19. The method of any of Aspects 17 to 18, further comprising: tracking a hand in the image data to determine the movement path of the indicator object relative to the target object, wherein the indicator object includes at least a portion of the hand.

Aspect 20. The method of Aspect 19, wherein the target object is held by the hand, and wherein the movement path of the indicator object is configured to rotate the target object.

Aspect 21. The method of any of Aspects 17 to 20, further comprising: removing a portion of a previous three-dimensional mesh to generate the three-dimensional mesh, wherein the portion of the previous three-dimensional mesh is based on the outline of at least the portion of the target object.

Aspect 22. The method of any of Aspects 17 to 21, further comprising: combining a volume with a previous three-dimensional mesh to generate the three-dimensional mesh, wherein the volume combined with the previous three-dimensional mesh is based on the outline of at least the portion of the target object.

Aspect 23. The method of any of Aspects 17 to 22, further comprising: detecting, based on the image data and previous image data of the scene, a change from a second perspective to the first perspective, wherein the target object is represented in the previous image data from the second perspective, wherein the previous image data is received from the image sensor before the image data.

Aspect 24. The method of any of Aspects 17 to 23, further comprising generating a shape of an edge of the three-dimensional mesh to match a shape of the outline of at least the portion of the target object

Aspect 25. The method of any of Aspects 17 to 24, further comprising: determining, based on second image data of the scene received from the image sensor, a second movement path of the indicator object relative to the target object, wherein the target object is represented in the second image data from the first perspective; and identifying, based on the second movement path of the indicator object and the first perspective, a second outline of at least a second portion of the target object, wherein the three-dimensional mesh is generated also based on the second outline of at least the second portion of the target object.

Aspect 26. The method of Aspect 25, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

Aspect 27. The method of any of Aspects 17 to 26, further comprising: determining, based on second image data of the scene received from the image sensor, a second movement path of the indicator object relative to the target object, wherein the target object is represented in the second image data from a second perspective; and identifying, based on the second movement path of the indicator object and the second perspective, a second outline of at least a second portion of the target object, wherein the three-dimensional mesh is generated also based on the second outline of at least the second portion of the target object.

Aspect 28. The method of Aspect 27, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

Aspect 29. A non-transitory computer-readable medium having stored thereon instructions that, when executed by one or more processors, cause the one or more processors to perform operations according to any of Aspects 1 to 17.

Aspect 30. An apparatus for image processing, the apparatus comprising one or more means for performing operations according to any of Aspects 1 to 17.

What is claimed is:

1. An apparatus for image-based modeling, the apparatus comprising:
at least one memory; and
at least one processor coupled to the at least one memory and configured to:
determine, based on image data of a scene received from an image sensor, a movement path of an indicator object relative to a target object, wherein the target object is represented in the image data from a first perspective;
identify, based on the movement path of the indicator object and the first perspective, an outline of at least a portion of the target object; and
generate a three-dimensional mesh based on the outline of at least the portion of the target object.

2. The apparatus of claim 1, wherein the at least one processor is configured to:
apply a texture to the three-dimensional mesh to generate a three-dimensional model, wherein the texture is based on a representation of the target object in the image data.

3. The apparatus of claim 1, wherein the at least one processor is configured to:
track a hand in the image data to determine the movement path of the indicator object relative to the target object, wherein the indicator object includes at least a portion of the hand.

4. The apparatus of claim 3, wherein the target object is held by the hand, and wherein the movement path of the indicator object is configured to rotate the target object.

5. The apparatus of claim 1, wherein the at least one processor is configured to:
remove a portion of a previous three-dimensional mesh to generate the three-dimensional mesh, wherein the portion of the previous three-dimensional mesh is based on the outline of at least the portion of the target object.

6. The apparatus of claim 1, wherein the at least one processor is configured to:
combine a volume with a previous three-dimensional mesh to generate the three-dimensional mesh, wherein the volume combined with the previous three-dimensional mesh is based on the outline of at least the portion of the target object.

7. The apparatus of claim 1, wherein the at least one processor is configured to:
detect, based on the image data and previous image data of the scene, a change from a second perspective to the first perspective, wherein the target object is represented in the previous image data from the second perspective, wherein the previous image data is received from the image sensor before the image data.

8. The apparatus of claim 1, wherein the at least one processor is configured to generate a shape of an edge of the three-dimensional mesh to match a shape of the outline of at least the portion of the target object.

9. The apparatus of claim 1, wherein the at least one processor is configured to:
determine, based on second image data of the scene received from the image sensor, a second movement path of the indicator object relative to the target object, wherein the target object is represented in the second image data from the first perspective; and
identify, based on the second movement path of the indicator object and the first perspective, a second outline of at least a second portion of the target object, wherein the three-dimensional mesh is generated also based on the second outline of at least the second portion of the target object.

10. The apparatus of claim 9, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

11. The apparatus of claim 1, wherein the at least one processor is configured to:
determine, based on second image data of the scene received from the image sensor, a second movement path of the indicator object relative to the target object, wherein the target object is represented in the second image data from a second perspective; and
identify, based on the second movement path of the indicator object and the second perspective, a second outline of at least a second portion of the target object, wherein the three-dimensional mesh is generated also based on the second outline of at least the second portion of the target object.

12. The apparatus of claim 11, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

13. The apparatus of claim 1, further comprising:
the image sensor.

14. The apparatus of claim 1, further comprising:
a display configured to display the three-dimensional mesh.

15. The apparatus of claim 1, further comprising:
a communication transceiver configured to transmit the three-dimensional mesh to a recipient device.

16. The apparatus of claim 1, wherein the apparatus includes at least one of a head-mounted display (HMD), a mobile handset, or a wireless communication device.

17. A method of image-based modeling, the method comprising:
determining, based on image data of a scene received from an image sensor, a movement path of an indicator object relative to a target object, wherein the target object is represented in the image data from a first perspective;
identifying, based on the movement path of the indicator object and the first perspective, an outline of at least a portion of the target object; and
generating a three-dimensional mesh based on the outline of at least the portion of the target object.

18. The method of claim 17, further comprising:
applying a texture to the three-dimensional mesh to generate a three-dimensional model, wherein the texture is based on a representation of the target object in the image data.

19. The method of claim 17, further comprising:
tracking a hand in the image data to determine the movement path of the indicator object relative to the target object, wherein the indicator object includes at least a portion of the hand.

20. The method of claim 19, wherein the target object is held by the hand, and wherein the movement path of the indicator object is configured to rotate the target object.

21. The method of claim 17, further comprising:
removing a portion of a previous three-dimensional mesh to generate the three-dimensional mesh, wherein the portion of the previous three-dimensional mesh is based on the outline of at least the portion of the target object.

22. The method of claim 17, further comprising:
combining a volume with a previous three-dimensional mesh to generate the three-dimensional mesh, wherein the volume combined with the previous three-dimensional mesh is based on the outline of at least the portion of the target object.

23. The method of claim 17, further comprising:
detecting, based on the image data and previous image data of the scene, a change from a second perspective to the first perspective, wherein the target object is represented in the previous image data from the second perspective, wherein the previous image data is received from the image sensor before the image data.

24. The method of claim 17, further comprising generating a shape of an edge of the three-dimensional mesh to match a shape of the outline of at least the portion of the target object.

25. The method of claim 17, further comprising:
determining, based on second image data of the scene received from the image sensor, a second movement path of the indicator object relative to the target object, wherein the target object is represented in the second image data from the first perspective; and
identifying, based on the second movement path of the indicator object and the first perspective, a second outline of at least a second portion of the target object, wherein the three-dimensional mesh is generated also based on the second outline of at least the second portion of the target object.

26. The method of claim 25, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

27. The method of claim 17, further comprising:
determining, based on second image data of the scene received from the image sensor, a second movement path of the indicator object relative to the target object, wherein the target object is represented in the second image data from a second perspective; and
identifying, based on the second movement path of the indicator object and the second perspective, a second outline of at least a second portion of the target object, wherein the three-dimensional mesh is generated also based on the second outline of at least the second portion of the target object.

28. The method of claim 27, wherein a shape of a first edge of the three-dimensional mesh is generated to match a shape of the outline of at least the portion of the target object, and wherein a shape of a second edge of the three-dimensional mesh is generated to match a shape of the second outline of at least the second portion of the target object.

29. A non-transitory computer-readable medium having stored thereon instructions that, when executed by one or more processors, cause the one or more processors to:
determine, based on image data of a scene received from an image sensor, a movement path of an indicator object relative to a target object, wherein the target object is represented in the image data from a first perspective;
identify, based on the movement path of the indicator object and the first perspective, an outline of at least a portion of the target object; and
generate a three-dimensional mesh based on the outline of at least the portion of the target object.

30. The non-transitory computer-readable medium of claim 29, wherein the instructions, when executed by the one or more processors, cause the one or more processors to:
apply a texture to the three-dimensional mesh to generate a three-dimensional model, wherein the texture is based on a representation of the target object in the image data.
